(19) United States
(12) Patent Application Publication
(10) Pub. No.: US 2020/0202495 A1
(43) Pub. Date: Jun. 25, 2020

(54) APPARATUS AND METHOD FOR DYNAMICALLY ADJUSTING DEPTH RESOLUTION

(71) Applicant: INDUSTRIAL TECHNOLOGY RESEARCH INSTITUTE, Hsinchu (TW)

(72) Inventor: Te-Mei WANG, Hsinchu City (TW)

(73) Assignee: INDUSTRIAL TECHNOLOGY RESEARCH INSTITUTE, Hsinchu (TW)

(21) Appl. No.: 16/506,254

(22) Filed: Jul. 9, 2019

(30) Foreign Application Priority Data
Dec. 19, 2018 (TW) 107145970

(51) Int. Cl. G06T 5/00; G06T 7/55; G06T 15/20

(52) U.S. Cl. CPC G06T 5/003; G06T 7/55; G06T 5/007; G06T 2207/20208; G06T 15/205; G06T 2215/12; G06T 2207/10028; G06T 5/002

(57) ABSTRACT

An apparatus for dynamically adjusting depth resolution is provided. The apparatus includes a depth capture module, an image capture module and a computing unit. The depth capture module obtains a set of images for disparity computation. The image capture module obtains a high-resolution image. The computing unit computes a disparity map and a corresponding depth map using the set of images obtained by the depth capture module, and sets a 3D region of interest according to a pre-defined object feature, the high-resolution image and the depth map. The 3D region of interest can be dynamically adjusted by tracking the movement of the object. In the 3D region of interest, the computing unit re-computes the depth map in higher resolution along Z axis by re-computing the disparity map in appropriate sub-pixels and allocating the required number of bits to store the sub-pixel disparity values.

This application claims the benefit of Taiwan application Serial No. 107145970, filed Dec. 19, 2018, the disclosure of which is incorporated by reference herein in its entirety.

### TECHNICAL FIELD

The disclosure relates in general to an image processing apparatus, and more particularly to an apparatus and a method for dynamically adjusting depth resolution.

### BACKGROUND

Depth resolution refers to the smallest depth difference that can be detected by a depth camera, and normally is obtained by computing two successive levels of disparity values. In a depth sensing range, the depth resolution is inversely proportional to the square of the disparity value. That is, the farther away from the depth camera, the lower the depth resolution. Since the resolution of the depth camera currently available in the market cannot be adaptively adjusted, problems such as the salient object lacking depth details or depth change being not smooth enough are commonly seen. Current solutions to the above problems can be divided into three categories. The first category is to perform post-processing, such as de-noising, hole filling, or smoothing, to the depth map. Although the first category can make the depth map look good, many depth details will be removed. The second category is to perform super-resolution processing to the depth map using machine learning with reference to extra information. However, the second category can only enhance the resolution of the depth map on the XY plane. That is, the depth map may look good, but the depth resolution (along the Z-axis) is not improved.

The third category is to change the depth sensing range by controlling the exposure time of the camera or the intensity of the projection light rather than adjusting the depth resolution. Such method is designed for a particular depth sensing apparatus, it cannot be used in other types of depth sensing apparatus.

Therefore, in addition to the above-mentioned solutions for enhancing the resolution of depth map on the XY plane, increasing the real depth resolution (along the Z-axis) to represent the required depth details under the restriction of limited computing resources becomes a prominent task for the industries.

### SUMMARY

The disclosure is directed to an apparatus and a method for dynamically adjusting depth resolution. Firstly, a salient object is detected. Then, a 3D region of interest in the space is set according to the detected salient object, wherein the 3D region of interest can be adjusted along with the movement of the object. Then, depth resolution in the 3D region of interest is enhanced to represent depth details.

According to one embodiment, an apparatus for dynamically adjusting depth resolution includes a depth capture module, an image capture module and a computing unit. The depth capture module obtains a set of images for disparity computation. The image capture module obtains a high-resolution image whose resolution is higher than the resolution of the depth capture module, wherein the image capture module and the depth capture module are synchronized. The computing unit computes a disparity map and a corresponding first depth map according to the set of images obtained by the depth capture module; sets a three-dimensional (3D) region of interest according to a pre-defined feature of a salient object, the high-resolution image and the first depth map; and computes a second depth map whose depth resolution is greater than the depth resolution of the first depth map in the 3D region of interest by re-computing the disparity map in sub-pixel values and allocating the number of bits required for storing the sub-pixel disparity values.

According to another embodiment, a method for dynamically adjusting depth resolution includes the following steps. First, a set of images for disparity computation and a synchronized high-resolution image whose resolution is higher than the resolution of the set of images are obtained. Second, a disparity map and a corresponding first depth map according to the set of images are computed. Third, a 3D region of interest is set according to a pre-defined feature of a salient object, the high-resolution image and the first depth map. Fourth, a second depth map whose depth resolution is greater than the depth resolution of the first depth map in the 3D region of interest is computed by re-computing the disparity map in sub-pixel values and allocating the number of bits required for storing the sub-pixel disparity values.

The above and other aspects of the disclosure will become better understood with regard to the following detailed description of the preferred but non-limiting embodiment(s). The following description is made with reference to the accompanying drawings.

### BRIEF DESCRIPTION OF THE DRAWINGS

FIG. 1A is a schematic diagram of an apparatus for dynamically adjusting depth resolution according to an embodiment of the present disclosure.

FIG. 1B is a schematic diagram of tracking the position of a salient object in the 3D region of interest according to an embodiment of the present disclosure.

FIGS. 2A-2C respectively are schematic diagrams of structured-light, active stereo, and passive stereo apparatuses for dynamically adjusting depth resolution according to an embodiment of the present disclosure.

FIG. 3 is a flow diagram of a method for dynamically adjusting depth resolution according to an embodiment of the present disclosure.

FIGS. 4A-4D respectively are architecture diagrams of a computing unit dynamically adjusting depth resolution according to an embodiment of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

Detailed descriptions of the disclosure are disclosed below with a number of embodiments. However, the disclosed embodiments are for explanatory and exemplary purposes only, not for limiting the scope of protection of the disclosure. Similar/identical designations are used to indicate similar/identical elements. Directional terms such as above, under, left, right, front or back are used in the following embodiments to indicate the directions of the accompanying drawings, not for limiting the present disclosure.

According to an embodiment of the present disclosure, an apparatus and a method for dynamically adjusting depth resolution are provided. The apparatus and the method of the present disclosure are capable of adaptively adjusting the depth resolution of a measuring region, that is, a high-resolution depth measurement is performed inside a pre-defined region of interest (ROI), and a low-resolution depth measurement is performed outside the region. The three-dimensional (3D) region of interest may be a human face, a unique shape, an object with closed boundary, or an object feature, a specified object position, or an object size (e.g., the position is searched towards the edges from the center of an image) automatically defined by the system.

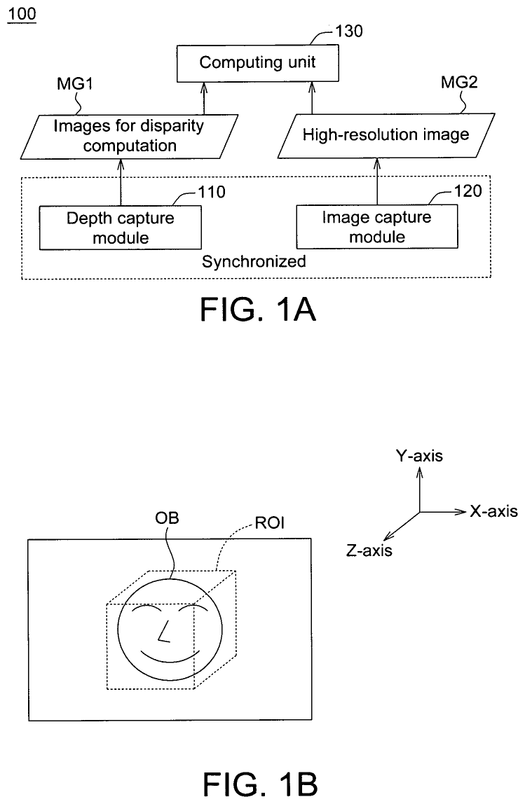

Referring to FIG. 1A, the apparatus 100 for dynamically adjusting depth resolution according to an embodiment of the present disclosure includes a depth capture module 110, an image capture module 120 and a computing unit 130. The depth capture module 110 obtains a set of images MG1 for disparity computation. The image capture module 120 obtains an image MG2 with higher resolution than MG1. The computing unit 130 receives synchronized MG1 and MG2 for subsequent processes, which can be realized by a central processor, a programmable microprocessor, a digital signal processor, a programmable controller, an application specific integrated circuit (ASIC), a field programmable gate array (FPGA) or any similar elements and software therein.

FIG. 1B illustrates a 3D region of interest (ROI) containing a salient object OB and the directions of XYZ axes. The 3D region of interest (ROI) is set by the computing unit 130 according to a pre-defined feature of a salient object OB, the high-resolution image MG2 and the first depth map computed from the disparity map. Besides, the 3D region of interest (ROI) can be dynamically adjusted by tracking a movement of the salient object OB.

In another embodiment, the computing unit 130 can automatically detect the position of the salient object OB to set a 3D region of interest (ROI) according to the high-resolution image MG2, the features between adjacent pixels, and the distribution of the corresponding first depth map. For example, the computing unit 130 can detect the features between adjacent pixels using a uniqueness algorithm such as the multi-scale saliency clue algorithm, the color contrast algorithm, the edge density algorithm, or the super-pixels straddling algorithm, and can further combine several pixels as a larger pixel set with reference to the distribution of the first depth map and the computing result of the super-pixel to detect the position of the salient object OB.

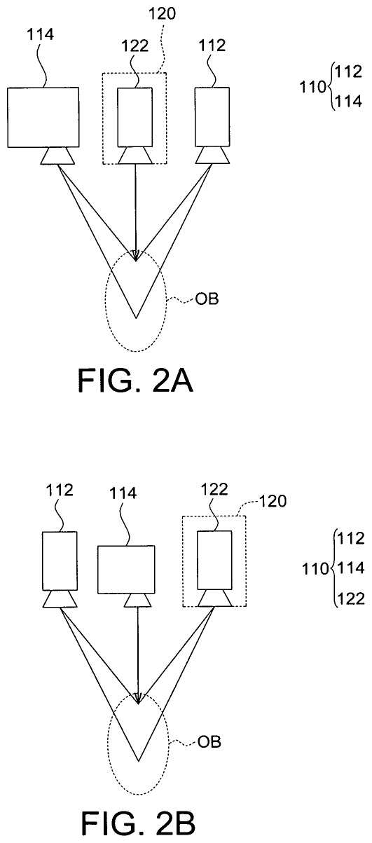

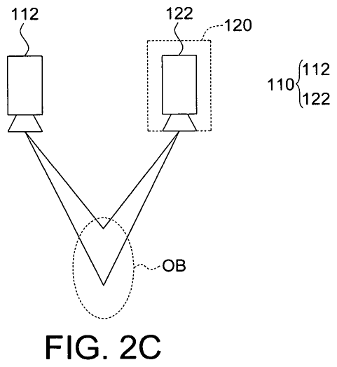

In an embodiment illustrated in FIG. 2A, the depth capture module 110 may include a camera 112 and a structured-light projector 114. The structured-light projector 114 projects a pre-defined pattern onto an object OB to form surface features, which can be, for example, a laser light projector, an infra-red projector, an optical projection apparatus, or a digital projection apparatus. The camera 112 obtains an image MG1 containing the object OB with a projected pattern for the computing unit 130 to compute the disparity map by matching with the pre-defined pattern. Moreover, the image capture module 120, which includes a camera 122 to obtain the high-resolution image MG2. The camera 122 can be, for example, a monocular camera or a color camera.

In an embodiment illustrated in FIG. 2B, the depth capture module 110 includes a first camera 112, a second camera 122, and a structured-light projector 114. The first camera 112 is configured to photograph a first view-angle image, and the second camera 122 is configured to photograph a second view-angle image. The resolution of the second camera 122 can be set to two modes: MG1 or MG2. In MG1 mode, the resolutions of the images captured by both cameras (112 and 122) are processed to be the same. The structured-light projector 114 is also enabled and synchronized to both cameras (112 and 122) to make the first view-angle image and the second view-angle image contain the pre-defined pattern for the computing unit 130 to compute the disparity map and a corresponding first depth map. In MG2 mode, the resolution of the second camera 122 is set to be higher than that of the first camera 112, being the image capture module 120 to capture the high-resolution image MG2; meanwhile, the structured-light projector 114 is disabled without projecting the pre-defined pattern.

In an embodiment illustrated in FIG. 2C, the depth capture module 110 includes a first camera 112 and a second camera 122. The first camera 112 is configured to photograph a first view-angle image, and the second camera 122 is configured to photograph a second view-angle image. Both cameras (112 and 122) are synchronized. The second camera 122, being the image capture module 120, captures a high-resolution image MG2. Since the resolutions of both cameras (112 and 122) are different, the computing unit 130 needs to decrease the resolution of the second view-angle image or increase the resolution of the first view-angle image to make the resolution of both images (MG1) be the same before computing the disparity map and a corresponding first depth map.

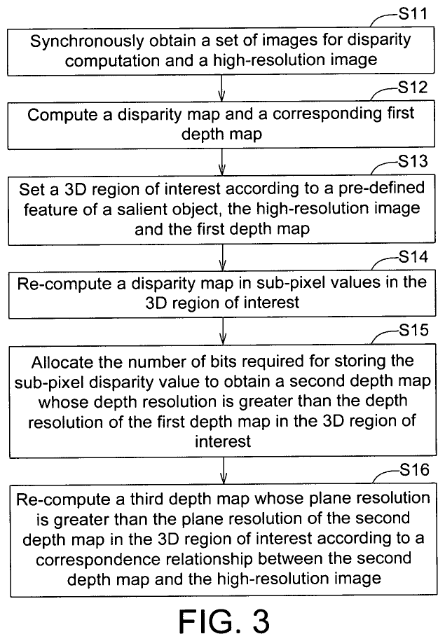

Details of the method for dynamically adjusting the depth resolution are disclosed below. Refer to FIGS. 1A, 1B and 3. FIG. 3 is a method for dynamically adjusting depth resolution according to an embodiment of the present disclosure. The method includes the following steps. In step S11, a set of images MG1 for disparity computation and a high-resolution image MG2 are synchronously obtained. In step S12, a disparity map and a corresponding first depth map are computed. In step S13, a 3D region of interest (ROI) is set according to a pre-defined feature of a salient object OB, the high-resolution image MG2 and the first depth map. In step S14, a disparity map in sub-pixel values in the 3D region of interest (ROI) is re-computed. In step S15, the number of bits required for storing the sub-pixel disparity values are allocated to obtain a second depth map, wherein in the 3D region of interest (ROI), the depth resolution of the second depth map is greater than the depth resolution of the first depth map, that is, the depth resolution of the salient object OB along the Z-axis is enhanced. In step S16, a third depth map can further be computed according to a correspondence relationship between the second depth map and the high-resolution image MG2, wherein the plane resolution of the third depth map in the 3D region of interest (ROI) is greater than the plane resolution of the second depth map, that is, the resolution of the salient object OB on the XY plane is enhanced.

In an embodiment, the set of images MG1 for disparity computation can be realized by a set of 320×240 (QVGA) images, a set of 640×480 (VGA) images, a set of 1280×720 images, or higher resolution. The high-resolution image MG2 can be realized by a 1280×720 (HD) image or an ultra-high resolution image. Moreover, when the feature of an object in the 3D region of interest is highly similar with the feature of a human face, the unique shape of an object, or a pre-defined feature of an object, this object can be specified as a salient object OB for use in subsequent procedure of dynamically adjusting the 3D region of interest.

In an embodiment, the resolutions corresponding to pixel coordinates in the 3D region of interest can be re-constructed to enhance the resolutions along the Z-axis and the XY plane according to the high-resolution image MG2, the first depth map and the second depth map. Thus, the image which is originally coarse (i.e., a low-resolution depth image) can be refined to represent more depth details (i.e., a high-resolution depth image).

In above embodiment, the computing unit 130 can compute the disparity map in appropriate sub-pixel values according to a correspondence relationship between the high-resolution image MG2 and the first depth map, and allocate the number of bits required for storing the sub-pixel values. In an embodiment, the computing unit 130 can compute the disparity map in sub-pixel values according to the baseline length and the focal length of the depth capture module 110, the required depth resolution, and the available bits. The more the bits required for storing the sub-pixel values, the higher the depth resolution along the Z-axis. Thus, the depth details can be better represented and the depth map quality can be enhanced.

The above disclosure is directed towards the improvement of depth resolution along the Z-axis. However, the computing unit 130 also can compute a high-resolution depth map in the 3D region of interest (ROI) according to a correspondence relationship between the high-resolution image MG2 and the second depth map to enhance the resolution on the XY plane. Since the resolutions are simultaneously enhanced in all of the three-dimensional directions in the 3D region of interest (ROI), better three-dimensional representation can be attained to enhance quality.

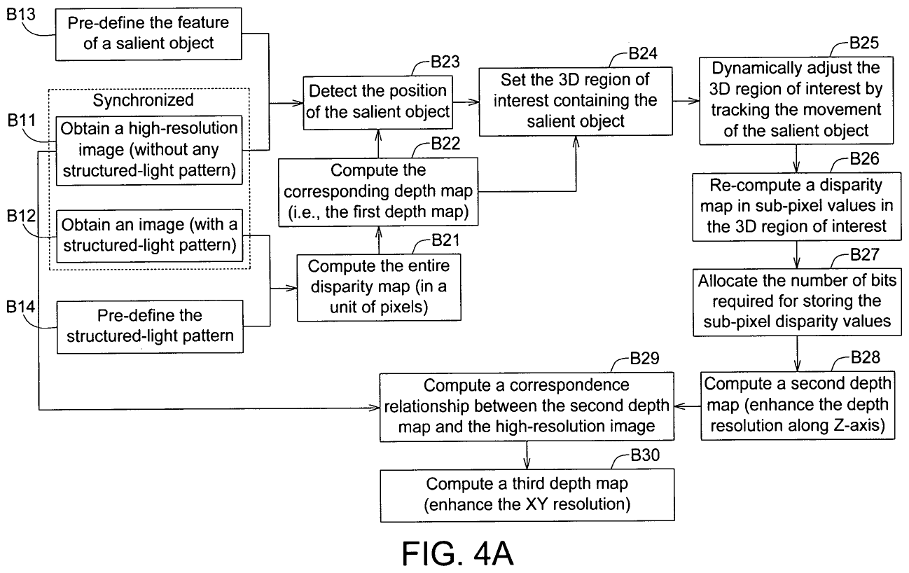

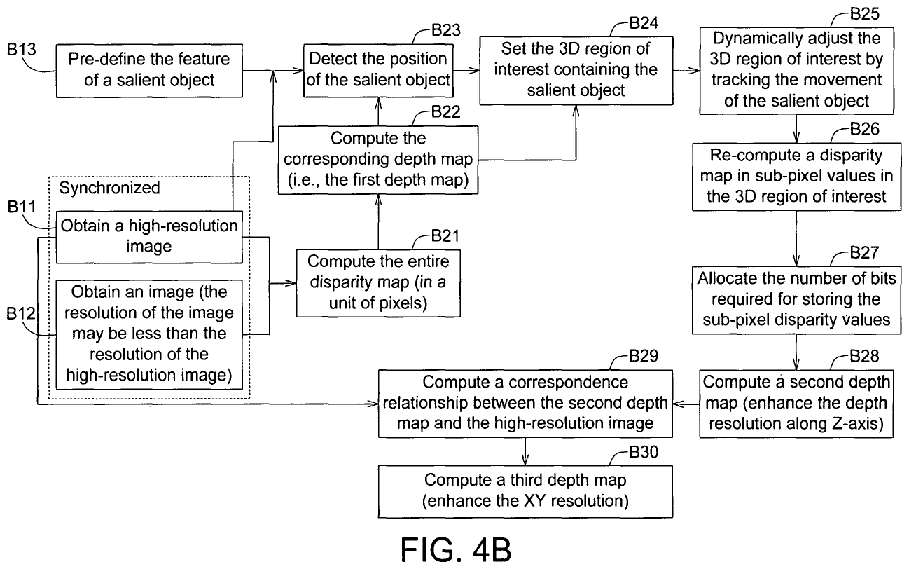

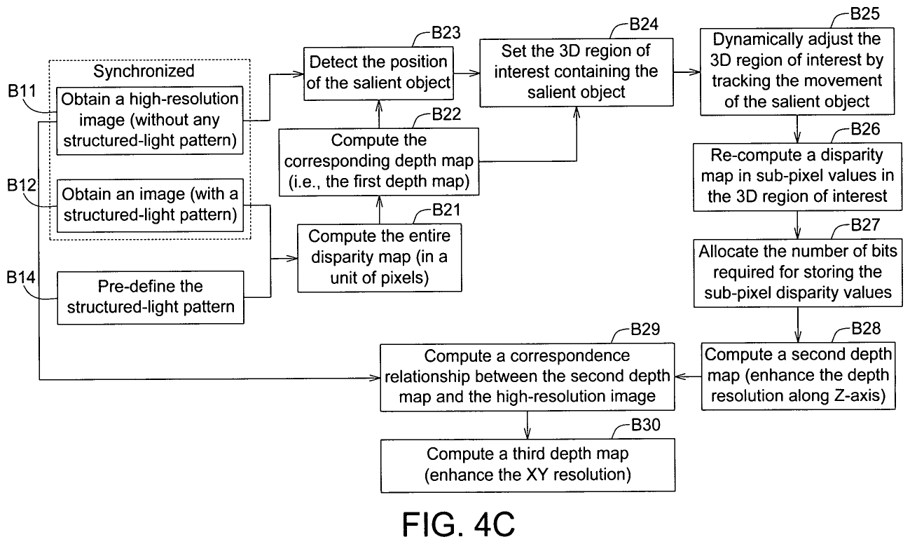

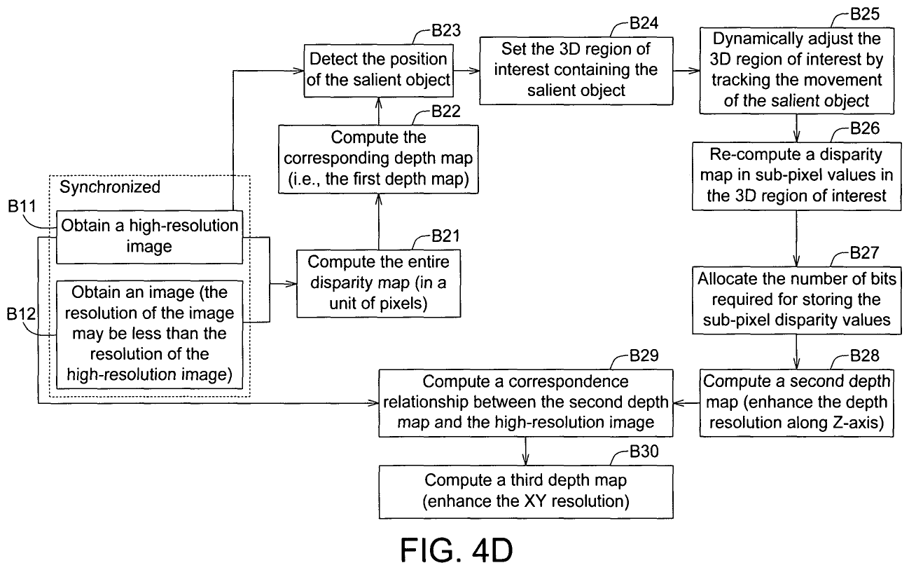

Referring to FIGS. 4A-4D, architecture diagrams of dynamically adjusting depth resolution according to an embodiment of the present disclosure are shown. As indicated in FIG. 4A, the depth capture module is, for example, the apparatus of FIG. 2A, which includes a high-resolution camera 122, a low-resolution camera 112, and a structured-light projector 114. The high-resolution camera 122 is configured to obtain a high-resolution image MG2 without any structured-light pattern (as indicated in step B11), and the low-resolution camera 112 is configured to obtain an image with a structured-light pattern (as indicated in step B12). The entire disparity map (in the unit of pixels) (as indicated in step B21) and the corresponding first depth map (as indicated in step B22) are computed according to the pre-defined structured-light pattern (as indicated in step B14) and the image with a structured-light pattern (as indicated in step B12). The position of the salient object (as indicated in step B23) is detected according to a pre-defined feature of the salient object (as indicated in step B13), the high-resolution image MG2 and the first depth map. The 3D region of interest containing the salient object is then set according to the position of the salient object (as indicated in step B24).

The computing unit can dynamically adjust the 3D region of interest (as indicated in step B25) by tracking the movement of the salient object. In the 3D region of interest, the computing unit can re-compute a disparity map in sub-pixel values (as indicated in step B26), allocate the number of bits required for storing the sub-pixel disparity values (as indicated in step B27), and compute the second depth map (as indicated in step B28) to enhance the depth resolution along the Z-axis. The computing unit can further compute a correspondence relationship between the second depth map and the high-resolution image (as indicated in step B29) in the 3D region of interest for computing a third depth map of a high-resolution to enhance the XY plane resolution (as indicated in step B30).

Refer to FIG. 4B. The depth capture module, such as an apparatus of FIG. 2B or FIG. 2C, includes a high-resolution camera 122 and a low-resolution camera 112. Although one more structured-light projector 114 is illustrated in FIG. 2B than in FIG. 2C, the principles for computing disparity are the same, and the structured-light projector 114 is merely used to add features for stereo matching. The high-resolution camera 122 can be configured in two mode: MG1 or MG2. The MG1 mode is for disparity computation, while the MG2 mode (as indicated in step B11) is for salient object detection and XY resolution refinement in the third depth map. The image in MG1 mode can be captured directly from camera 122 or be processed from the image in MG2 mode. For disparity computation, the resolution of both cameras (112 and 122) should be the same. The resolution of the high-resolution image (MG2) may be decreased to be the same as that of the low-resolution image or the resolution of the low-resolution image may be increased to be the same as that of the high-resolution image before computing the entire disparity map (in the unit of pixels) (as indicated in step B21) and the corresponding first depth map (as indicated in step B22). Details of remaining steps B23 to step B30 are already disclosed in above embodiments, and are therefore not repeated here.

Refer to FIG. 4C. FIG. 4C is similar to FIG. 4A except that after the high-resolution image MG2 and the first depth map are obtained, the position of the salient object is automatically detected to set a 3D region of interest. The computing unit 130 can detect the features between adjacent pixels using a uniqueness algorithm such as multi-scale saliency clue algorithm, color contrast algorithm, edge density algorithm, or super-pixels straddling algorithm to obtain the position of the salient object with reference to the distribution of the first depth map without using the pre-defined feature of the salient object (step B13 is omitted). Details of remaining steps are already disclosed in above embodiments, and are therefore not repeated here.

Refer to FIG. 4D. FIG. 4D is similar to FIG. 4B except that after the high-resolution image MG2 and the low-resolution image are obtained, the position of the salient object (as indicated in step B23) is automatically detected using a uniqueness algorithm, and a 3D region of interest (as indicated in step B24) is set according to the position of the salient object without using pre-defined feature of a salient object (step B13 is omitted). Details of remaining steps are already disclosed in above embodiments, and are therefore not repeated here.

In an embodiment, the method for dynamically adjusting depth resolution can be implemented as a software program, which can be stored in a non-transitory computer readable medium, such as a hard disk, a disc, a flash drive, or a memory. When the processor loads the software program from the non-transitory computer readable medium, the method of FIG. 3 can be performed to adjust depth resolution. Steps S11-S16 of FIG. 3 can together be implemented by a software unit and/or a hardware unit; or, some steps are implemented by a software unit and some other steps are implemented by a hardware unit, and the present disclosure does not impose specific restrictions.

According to the apparatus and the method for dynamically adjusting depth resolution disclosed in above embodiments of the present disclosure, depth resolution and plane resolution can be increased in the 3D region of interest to represent a more refined depth map. Since the 3D region of interest occupies a relatively smaller area, desired resolution and computing speed can both be attained. Furthermore, the position of the 3D region of interest can be adjusted along with the movement of the salient object. The apparatus of the present disclosure can be used in high-resolution 3D measurement, such as human face recognition, medical or industrial robots, or virtual reality/ augmented reality (VR/AR) visual system to enhance the quality of 3D measurement.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An apparatus for dynamically adjusting depth resolution, comprising:
a depth capture module configured to obtain a set of images for disparity computation;
an image capture module configured to obtain a high-resolution image whose resolution is higher than the resolution of the depth capture module, wherein the image capture module and the depth capture module are synchronized; and
a computing unit configured to
compute a disparity map and a corresponding first depth map according to the set of images obtained by the depth capture module,
set a three-dimensional (3D) region of interest according to a pre-defined feature of a salient object, the high-resolution image and the first depth map, and
compute a second depth map whose depth resolution is greater than the depth resolution of the first depth map in the 3D region of interest by re-computing the disparity map in sub-pixel values and allocating the number of bits required for storing the sub-pixel values.

2. The apparatus according to claim 1, wherein the computing unit further computes a third depth map whose plane resolution is greater than the plane resolution of the second depth map in the 3D region of interest according to a correspondence relationship between the second depth map and the high-resolution image.

3. The apparatus according to claim 1, wherein the depth capture module comprises a camera and a structured-light projector, the structured-light projector projects a specific pattern onto an object, and the camera obtains an image containing the specific pattern and the object.

4. The apparatus according to claim 1, wherein the depth capture module comprises a first camera configured to obtain a first view-angle image and a second camera configured to obtain a second view-angle image.

5. The apparatus according to claim 1, wherein the computing unit, after setting the 3D region of interest, dynamically adjusts the 3D region of interest by tracking a movement of the salient object.

6. The apparatus according to claim 1, wherein the computing unit automatically detects a position of the salient object to set the 3D region of interest according to the high-resolution image, a set of unique features between adjacent pixels, and a distribution of the corresponding first depth map.

7. The apparatus according to claim 1, wherein the computing unit computes the disparity map in sub-pixel values and allocates the number of bits required for storing the sub-pixel values according to a baseline length and a focal length of the depth capture module, a required depth resolution of the salient object, and available bits to store depth map.

8. A method for dynamically adjusting depth resolution, comprising:
obtaining a set of images for disparity computation and a synchronized high-resolution image whose resolution is higher than the resolution of the set of images;
computing a disparity map and a corresponding first depth map according to the set of images;
setting a 3D region of interest according to a pre-defined feature of a salient object, the high-resolution image and the first depth map; and
computing a second depth map whose depth resolution is greater than the depth resolution of the first depth map in the 3D region of interest by re-computing the disparity map in appropriate sub-pixel values and allocating the number of bits required for storing the sub-pixel values.

9. The method according to claim 8, further comprising computing a third depth map whose plane resolution is greater than the plane resolution of the second depth map in the 3D region of interest according to a correspondence relationship between the second depth map and the high-resolution image.

10. The method according to claim 8, wherein obtaining the set of images comprises projecting a specific pattern onto an object and obtaining an image containing the specific pattern and the object for computing the disparity map.

11. The method according to claim 8, wherein computing the disparity using the set of images comprises photographing a first view-angle image and a second view-angle image, and computing the disparity according to corresponding pixel points in the first view-angle image and the second view-angle image.

12. The method according to claim 8, further comprising, after the 3D region of interest is set, dynamically adjusting the 3D region of interest by tracking a movement of the salient object.

13. The method according to claim 8, wherein setting the 3D region of interest comprises automatically detecting a position of the salient object to set the 3D region of interest according to the high-resolution image, a set of unique features between adjacent pixels, and a distribution of the corresponding first depth map.

14. The method according to claim 8, wherein obtaining the second depth map comprises re-computing the disparity map in appropriate sub-pixel values and allocating the number of bits required for storing the sub-pixel values according to a baseline length and a focal length of the depth capture module, a required depth resolution of the salient objet, and available bits to store depth map.
